(19) United States
(12) Patent Application Publication
(10) Pub. No.: US 2010/0174554 A1
(43) Pub. Date: Jul. 8, 2010

(54) ADMINISTRATION OF DRUGS

(75) Inventor: Ronald Christopher Monson, Victoria (AU)

Correspondence Address: CONNOLLY BOVE LODGE & HUTZ LLP, 1875 EYE STREET, N.W., SUITE 1100, WASHINGTON, DC, 20006, US

(73) Assignee: VICTORIA UNIVERSITY, Footscray (AU)

(21) Appl. No.: 12/063,800

(22) PCT Filed: Aug. 14, 2006
(86) PCT No.: PCT/AU06/01146

§ 371 Date: Feb. 14, 2008

(30) Foreign Application Priority Data
Aug. 15, 2005 (AU) 2005904363

(51) Int. Cl. G06Q 50/00; G06F 3/048

(52) U.S. Cl. 705/3; 715/764

(57) ABSTRACT

A method of administering a drug to a patient which involves providing a single interface for entry of data including one or more of drug identity, dosage rate, prescribed dosage form, concentration and form of drug, and patient body weight, processing the input data using an algorithm which converts the input data into a set of instructions for administering the drug including the amount and time for the first and subsequent administrations, administering the drug and recording the amount and times on the patients record.

This invention relates to the safe administration of drugs in the hospital environment.

### BACKGROUND TO THE INVENTION

In modern health care and particularly in the hospital environment there a large number of drugs to be administered by a range of techniques including orally, by injection and intravenously. The drugs themselves come in a range of dosage forms and usually require some preparation particularly as dosage rates vary according to patient's condition and also their body weight. With nursing staff working different shifts keeping a record of what has been administered requires care and a certain amount of bookkeeping. The current lack of automation and the mathematical abilities of nurses has produced unacceptable error rates. Indeed, apart from the human cost, several measures have estimated that the world wide cost of errors attributable to incorrect drug administration exceeds a billion dollars. Competence in drug calculations has been a long-standing issue at the undergraduate level in Nursing education and is an important root cause in the problems later observed in the clinical environment. In an Australian study conducted in 2000 19% of final year candidates could not achieve a proficiency level of 50% in a standard Drug Calculation. In this test 36% of students achieved a score of 80% (which was considered an accepted level of proficiency) whilst only 3% achieved a score of 100%.

A lack of automation has been widely identified as a contributing factor in drug-calculation errors. The benefits of introducing a level of automation are clear and numerous and include: 1) Machines perform multi-step algorithms far more efficiently and accurately 2) A final safety check can be incorporated by linking to electronic pharmacopoeia 3) Analysis of an electronic ADE (Adverse Drug Event) audit trail can lead to incremental improvements in the system 4) An opportunity for this automation to be integrated with new technology associated with emerging medical information systems and/or hand-held devices.

Some attempts have been made to address this problem. U.S. Pat. No. 4,807,170 discloses a handheld calculator for IV administration. Different screens are used for the different types of calculations which vary according to the input data available.

U.S. Pat. No. 5,772,635 discloses an infusion system with an integrated drug dosage calculation system.

U.S. Pat. No. 5,915,971 discloses a tutorial device for teaching nurses the range of calculations that need to be used.

U.S. Pat. No. 6,167,412 discloses a general handheld calculator for medical use and has a wide range of available functions.

All of these attempts to address this problem contain the drawback that they rely on a particular interface/mode to be created for a particular problem (one screen interface for each calculation type). This, in turn places a burden on the nurse to first find the correct interface (assuming it even exists in the system) using a certain level of mathematical understanding.

Despite the obvious advantages of automation there does not currently exist any widespread automation of drug calculations in the clinical setting. This appears to be due to serious usability issues that arise from adopting the current “1-interface 1-calculation” approach.

It is an object of this invention to provide a convenient error-proof means of calculating the correct dose for any particular drug and patient.

### BRIEF DESCRIPTION OF THE INVENTION

To this end the present invention provides a method of administering a drug to a patient which involves providing an interface for entry of data including one or more of drug identity, dosage rate, prescribed dosage form, concentration and form of drug, and patient body weight, processing the input data using an algorithm which converts the input data into a set of instructions for administering the drug including the amount and time for the first and subsequent administrations, administering the drug and recording the amount and times on the patients record. This invention makes automation of the calculations feasible because it is based on an insight that all drug calculations follow a certain pattern and the resulting innovation is that a single algorithm can be adapted to answer any type of drug calculation that nurses need to perform.

Performing these calculations from a single interface means that any arithmetic can now be automated thereby becoming more efficient and reliable as well as opening up the possibility of automated checks on any final dosage calculated. This invention has demonstrated this fact with a single interface that can perform almost all the calculations required of nurses.

The algorithm used in this invention embodies a more uniform way of conceptualizing all the different types of individual calculations that are required of nurses and is in some sense an example of the whole (new algorithm) being greater than the sum of the parts(all the variety of individual calculations).

The input format is a kind of a “shop window” to the algorithm.

The technology encompasses a simple calculator interface that can produced as a mass market device with the potential to create additional modules to incorporate toxicology, patient history and database management.

The technology can (depending on the relevant computing infrastructure) be embodied in a multitude of interfaces. These include (but are not limited to) a standard computer screen, existing hand-held computers (pda, pocket PC, mobile phones) as well as potentially, a custom-made hand-held device dedicated to drug-dosage calculations

A computer-screen accessible in hospital wards may be used. Networked computers are commonplace in hospitals and provide an ideal location for the interface. Hand-held calculators or a PDA may be useful for hospitals without this computing infrastructure.

The major point of difference between the method of this invention and other calculators is the use in this invention of a single interface. Without such an interface, a catch-22 situation occurs in any system with a 1-1 correspondence between its interfaces and the calculations it automates. That is, in a system with a small number of interfaces/calculations, any individual interface can be quickly found but the small number of corresponding calculations severely limits its functionality and usefulness. Increase the number of interfaces on the other hand, and the system's usability rapidly diminishes as users are forced to select a relevant one amongst a large array of interfaces (assuming that one even exists). It is this inbuilt limitation that is arguably the reason why conventional calculators are currently not in widespread use in the clinical setting.

This advantage is derived from the fact that the method of this invention constructs Formulae instead of Selecting Formulae. The method of this invention is able to automate an array of functions from the one interface which is another point of difference in its approach towards the automation of drug calculations. That is, instead of a “black-box” approach embodied in a formulae's selection, a customized formula is constructed directly from the dose's description. The net effect of this is that a human's input is emphasized where it is most needed (in constructing a formulae from a clinical situation) and de-emphasised it where it is least needed (i.e. in the formula's actual evaluation).

### DETAILED DESCRIPTION OF THE INVENTION

A preferred form of the invention is illustrated in the drawings in which:

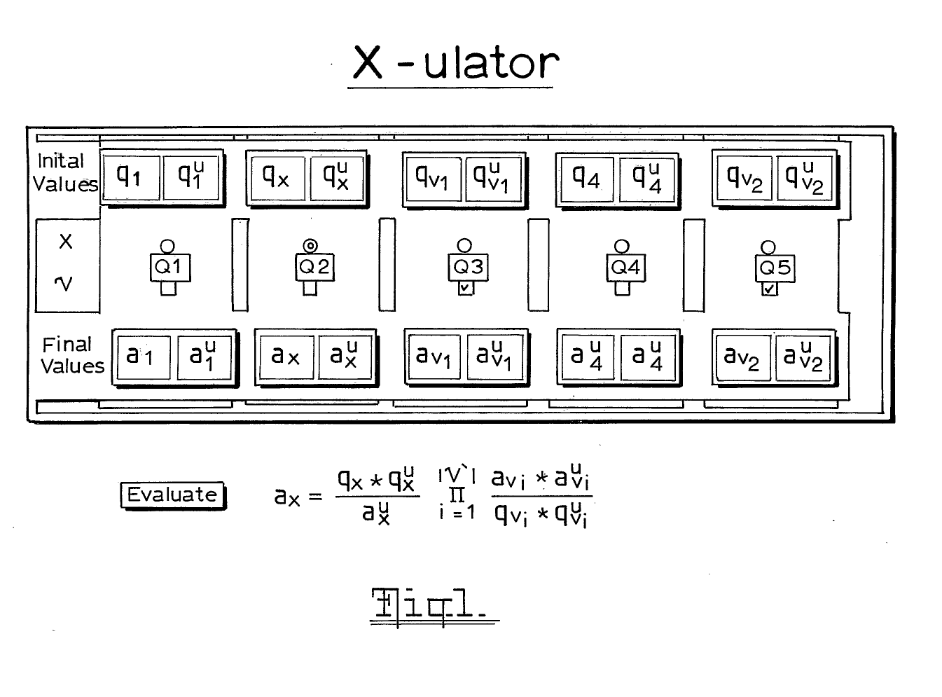

FIG. 1 illustrates the generic interface screen and formula used in this invention.

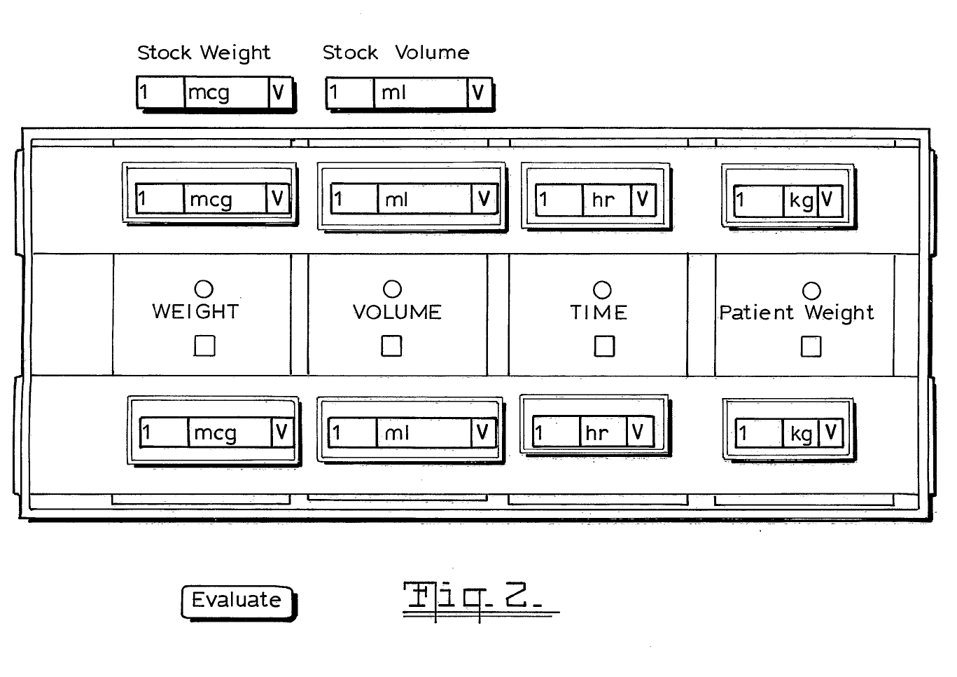

FIG. 2 illustrates the interface screen used in this invention;

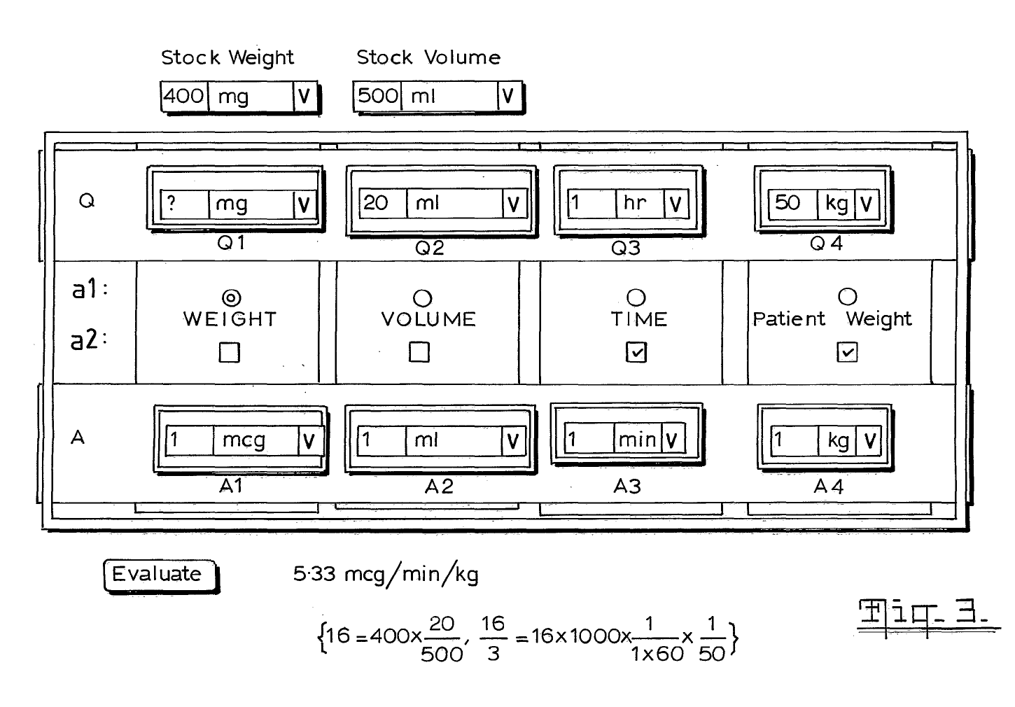

FIG. 3 shows the screen with an answer to a typical computation;

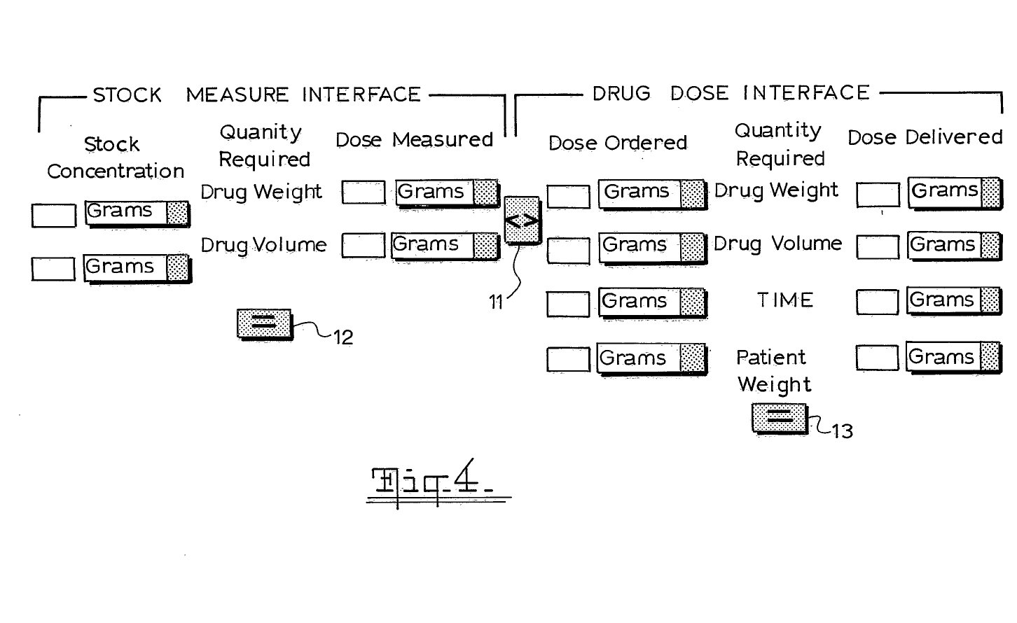

FIG. 4 illustrates an interface screen according to another embodiment of this invention.

With reference to FIG. 1 the formula is derived as follows:

Let Q={1, . . . , n } index a sequence of facets, Q₁, Q₂, . . . , Qₙ. Each facet can be thought of as representing a particular feature of a system which can be measured in any convenient unit. From these n different facets, we distinguish one, x^{ε}Q which is to correspond to a feature of particular interest. Frequently, the amount of this distinguished facet is dependent on, and occurs in proportion to, the amounts of other, accompanying and in some sense independent facets. Let V index the sequence of these other facets (Hence, V^{ε}Q-{x}). The magnitude of each facet measured can be determined by two components, {qᵢ, qᵢ^{u}} where qᵢ, is a numerical value that describes the amount of the unit qᵢ^{u}—which, although designed to denote a unit, is actually a number that represents a multiple of some assumed base unit (typically this would be a SI unit so that where the unit to be denoted is a “millilitre”, for example, we would have qᵢ^{u}=10⁻³). The dependence of the amount of the distinguished facet—(qₓ*qₓ^{u}) on the amounts of other selected facets (which is indexed by V) can be stated in a list as follows:

{{qₓ,qₓ^{u}}←|{qᵥ_{₁},qᵥ_{₁}^{u}},{qᵥ_{₂},qᵥ_{₂}^{u}} . . . {qᵥ_{_{|ν|}},qᵥ_{_{|ν|}}^{u}}} (1)

That is, this list states that an amount of qₓ*qₓ^{u} of facet Qₓ occurs in a system where measured amounts of qᵥ_{₁}*qᵥ_{₁}^{u}, qᵥ_{₂}*qᵥ_{₂}^{u}, . . . , qᵥ_{_{|ν|}}*qᵥ_{_{|ν|}}^{u} of the respective facets Qᵥ_{₁}, Qᵥ_{₁}, . . . Qᵥ_{_{|ν|}} are also observed, or required to be present. The label q was used to group this collection of measurements since such a collection frequently describes the given information from a question whose answer is simply the new amount of the distinguished facet that becomes present due to the occurrence of different amounts of the other independent facets. This answer is obtained by performing the appropriate unit conversions and using the assumption that changes in the amount of the distinguished facet occur in proportion to any changes made in the other independent facets. Using the previous list notation we see that the new situation can be described by:

{{aₓ,aₓ^{u}}←|{aᵥ_{₁},aᵥ_{₁}^{u}},{aᵥ_{₂},aᵥ_{₂}^{u}} . . . {aᵥ_{_{|ν|}},aᵥ_{_{|ν|}}^{u}}} (2)

with aₓ representing the new amount of the distinguished facet that is to be determined (in chosen units aₓ^{u}). From this we see that since the amount of facet Qᵥ_{ᵢ} has changed by a factor of

$$\frac{{a}_{{v}_{i}} * {a}_{{v}_{i}}^{u}}{{q}_{{v}_{i}} * {q}_{{v}_{i}}^{u}} ,$$

the proportional relationship means that the amount of facet Qₓ (which is initially equal to qₓ*qₓ^{u}) also changes by this factor. Repeating this for all the factor changes associated with the other facets (and multiplying the results) we see that a measure of the total factor change due to all the independent facets can be determined by finding ax aₓ follows:

$${a}_{x} = \frac{{q}_{x} * {q}_{x}^{u}}{{a}_{x}^{u}} {\prod }_{i = 1}^{\vert {v}^{′} \vert} \frac{{a}_{{v}_{i}} * {a}_{{v}_{i}}^{u}}{{q}_{{v}_{i}} * {q}_{{v}_{i}}^{u}} \qquad ( 3 )$$

Essentially, equation (3) is just a straightforward application of the notion of proportionality amongst measurements of disparate units. Such an application does however, appear in different guises in a surprisingly diverse set of computations and hence, developing a flexible computer interface into which all these different computations can be inscribed, offers several benefits. Firstly, repeatedly performing such inscriptions develops an awareness that a variety of problems are really special cases of this more fundamental one (i.e. involving proportionality and unit conversions). Hence, recognizing that a particular problem is, in fact, such a special case can then lead to its immediate solution. Secondly, since inscribing a problem into an interface is equivalent to translating it into a more fundamental problem, if the solution to the fundamental problem has already been implemented in a computer program, then a solution to the problem of interest can be immediately and automatically computed. This automation can dramatically improve efficiency and accuracy of solutions in a wide range of problems. The importance of this automation is accentuated when such solutions are required from those with weak mathematical backgrounds or, even for those with strong numerate skills, for managing all the details in the case where the size of {V} becomes unwieldy.

The values for terms in expressions (1) and (2) are taken form the respective “Initial Values” and “Final Values” rows. Note that in this example the facet of interest is Q₂ which is indicated by the radio button selection in row x which in turn sets the corresponding values of {qₓ, qₓ^{u}} and {aₓ, aₓ^{u}}. The other facets on which Q₂ have been chosen to (proportionally) depend on are Q³ and Q⁵ which are indicated by the check box selections in row V thereby setting the values of {qᵥ_{₁}, qᵥ_{₁}^{u}}, {aᵥ_{₁}, aᵥ_{₁}^{u}} and {qᵥ_{₂}, qᵥ_{₂}^{u}}, {aᵥ_{₂}, aᵥ_{₂}^{u}}. The facets Q₁ and Q⁴ are not relevant to this particular calculation (of aₓ) and hence any values in the positions of {q₁, q₁^{u}}, {a₁, a₁^{u}}, {q₄, q₄^{u}}, {a₄, a₄^{u}} are ignored (they may however, become relevant in other possible calculations in which case the corresponding radio-button or check box would be selected). Note that this means that in any given computation there can be a certain redundancy built into the interface with the entries of certain columns left unused. This redundancy however (which in the actual operation of the interface can be made clear by dimming the unused columns), is actually a consequence of an important feature whereby all the different calculations can be performed from a single interface. This feature reduces the amount of time for users to find a page-specific calculation and also promotes an awareness of the fundamental proportionality argument being applied across seemingly diverse problems.

The point of the interface is to compute the amount of the facet of particular interest (which is dependent and proportional to the amounts of certain other facets as specified in the “initial values” row) when the amounts of the independent facets are varied (as specified in the “Final Values” row). Hence the amount of the facet of particular interest (in units aₓ^{u}) is given by the expression to the right of the “Evaluate” button and it is this amount that is output when the button is clicked. The algorithm is totally extensible by increasing the number of facets of interest in any system being studied. That is, the size of Q can be increased arbitrarily which in turn, would be reflected in the interface through the appearance of additional columns. Indeed, the usefulness of this interface is likely to increase exponentially with the number of facets of a system being measured. This is because all the different facets and any possible conversions can be conveniently managed from the one interface—as opposed to the increasingly complex arithmetical calculations required without the interface. This extensibility is also likely to be exercised as increased understandings of systems frequently occur through analyzing the effects of more and more of its constituent facets. For example, the standard facets associated with the most effective amount of a drug to administer includes volume (as specified by stock concentration) patient mass and time; it is feasible however, that more precise and effective dosages can be delivered by incorporating such facets such as surface area, patient age and potentially, DNA sequences. (Note that these would then appear as additional columns and without any alteration to the basic algorithm used in equation (3) assuming that increases in any selected facet cause proportional increases in any selected facet of interest—if the relationship turns out not to be proportional then the algorithm can be straightforwardly adjusted as required).

The input fields as shown in the FIGS. 2 and 3 of the drawings, are arranged in rows on an interface screen. The weight and volume units to be used are set in the top row in the stock weight and stock volume. Drop down menus in each window provide a range of units to be selected.

Learning how to apply the interface of this invention to a range of Drug Calculations is a two-step process. The first step involves specifying (FIG. 2. Row Q) the relevant information provided by the problem (typically this describes the dose to be administered). The second step involves specifying (FIG. 2. Rows A, a1, a2) what the problem is asking (typically this involves describing the dose in terms of other quantities of interest). With these specifications correctly entered, clicking “Evaluate” actuates the algorithm to output the correct answer as illustrated in FIG. 3. That is, with respect to FIG. 2. there are the following steps:

1. Specify the problem:
a) Specify the relevant quantities (along with the correct units) in Row Q (The“Stock Weight ” and “Stock Volume” fields can also be used if necessary).

2. Specify the answer:
a) Specify the “main quantity” being sought by selecting the corresponding radio button in row a1.
b) Specify the other quantities (which the “main quantity” varies with respect to) by selecting the corresponding checkboxes in row a2.
c) Specify the quantities (along with the correct units) in row A in which the answer needs to be expressed.

Note that learning to use the interface is perhaps best accomplished by practising on a variety of examples. A range of examples (along with their Solutions in terms of the steps described above) may be provided within links on the interface screen. Clicking the “Evaluate” button within these produces the correct answer for any particular question.

The interface contains and that particular problems may not require the filling in of every single field. What relevant fields used by the interface are specified by rows a1 and a2. In particular, the checkbox's in row a2 specify that information in the corresponding columns (as indicated by the green strips) be used while the radio-button selection in row al specifies the “main quantity” (of the columns selected in a2) that is being requested in the question.

In row Q the pairs Q1-Q4 are filled in directly from the information as described in the question. If the question contains information about a stock concentration these can be entered via the Stock Mass and Stock Volume fields.

In all the fields Q1-Q4 & A1-A4 if the information given in the question is given in “per form” (e.g. ml/kg/hr) fill in the numerical field with a 1.

Mathematically what the interface essentially does is the following: For the column checked by the radio button, the value in the top row Q (having first been converted into the same units as that specified in the corresponding bottom row A) is divided by the corresponding column value in the bottom row A. For the columns selected by the checked boxes, the value in the top row Q (having first been converted into the same units as that specified in the corresponding bottom row A) is divided into the corresponding column value of the bottom row A. The numbers so obtained in these steps are then all multiplied together. It turns out that this generic conceptualization underpins any type of calculation although you can always see the actual arithmetical calculations underneath the computed answer as shown in FIG. 2.

The problem solved in FIG. 2 is:

Order: Dopamine infusion 20 ml/1 hr

Stock: Dopamine 400 mg in 5% Dextrose 500 ml

1. If the patient is 50 kg how many mcg/min/kg will be infused?

The initial dose to be administered is contained in the order “Dopamine infusion 20 ml/1 hr ” as reflected in the entries of Q2 and Q3. It is to be assumed that the initial dose was devised for the patient being discussed and hence it has been calculated per 50 kg as shown in Q4. There are two questions being posed here; the first involves a Weight rate per kilogram of patient whereas the second asks for a Weight rate that includes the patient's entire weight. Since the initial dose is a volume, this volume first needs to be converted into a weight using the concentration as provided in the stock details. Hence, the details contained in the Stock information “Dopamine 400 mg in 5% Dextrose 500 ml” appear in the “Stock Weight” and “Stock Volume” fields while a “?” is inserted in the numeric field of Q1. The “main quantity” of interest is contained in the “mcg” part of the “mcg/min/kg” request leading to the checking of the “Weight” radio button of row a1 in FIG. 2. This weight is to be determined in relation to both the weight of the patient and over a particular time period and hence the “Patient Weight” and “Time” checkboxes of row a2 both need to be checked in FIG. 2. The dosage weight is being calculated per (1) minute and (1) kilogram of patient as reflected in the entries of A3 and A4 respectively.

Clicking the “Evaluate” button of FIG. 2. yields an answer of “5.33 mcg/min/kg ”. The bracketed response beneath the answer shows the actual arithmetic performed. In particular, The first entry in the list below the answer shows the intermediate calculation that uses the stock concentration to determine the “?” entry of Q1—namely that the 20 ml volume equates to a weight of 16 mg in the infusion. The second entry then shows how the final answer of 540 is obtained in the normal operation of the interface using rows Q and A.

FIGS. 1 and 2 depict an interface of 28 inputs that can perform all possible drug calculations that use Dose Weight and Volume, Time and Patient Weight.(Note that all these are not used in every single calculation but each calculation uses a certain subset of these inputs depending on what inputs are “activated” by the user).

It is the ability, in a single interface, of being able to perform a large number of dosage calculations from a relatively small number of inputs that distinguishes this invention from prior-art devices. This property can be made precise by measuring the device's “Interface Efficiency” (IE) where IE=#calculations/# inputs. For comparison purposes, the Interface Efficiency of prior-art can be meaningfully measured by concatenating all prior art (interfaces) into a single “super interface”. The (much larger) number of inputs appearing in the resulting “super interface” produces a significantly reduced Input Efficiency that effectively renders it unusable in practice.

While other embodiments (e.g. design improvements) of this interface are possible, the inventions core effectiveness ultimately resolves to the large Interface Efficiency it produces (which followed naturally from recognizing the common principle of proportionality used in the algorithms for almost all dosage calculations).

An example of another embodiment of this invention is given in FIG. 4 where a horizontal format that promotes a left to right workflow as well is used together with the introduction of a commonly needed stock-concentration component. That is, The first calculations in the stock measure interface on the left convert the drug as stocked into the same units as prescribed by the physician and the second calculation in the drug dose interface presents the unit dosage to be given to the patient. The two calculations are separated by a screen button or valve 11 that connects the stock measure interface to the drug dose interface so that output from a stock concentration calculation can be plugged back into the drug dose interface. When values are entered in the drug measure interface the values are colour coded as primary and secondary values and pressing the equal button 12 displays the calculation. The drug dose interface works in a similar way and pressing the equal button 13 displays the calculation.

In the interface illustrated, four horizontal bands (corresponding to drug weight, drug volume, time and patient weight) have been used. This choice has been made because the overwhelming majority of calculations required by nurses employ these variables alone. There are however, other quantities that are sometimes used (e.g. a patient's surface area, age etc.). Furthermore, it is inevitable that medical advances will uncover the importance of other quantities (e.g. patient's sex, kidney function, DNA etc) that need to be routinely factored into standard drug administration. Despite the improved embodiment presented in FIG. 4 and/or other potential extensions, the inventions core idea of obtaining a maximal IE ratio is always to be retained since it is this feature that ultimately renders the device usable in the face of any increases in complexity.

The interface and algorithm of this invention is “future proof” in one important sense. The current infrastructure contains an inbuilt extensibility whereby these other quantities found to affect a dose's efficacy can be subsequently and seamlessly added. That is, the interface's design allows news rows to be added for each new variables found to impact on a drug's dose.

The algorithm illustrated has been written in Mathematica. However the algorithm may be written in any suitable programming language depending on the hardware used. For calculators or hand held PDA's the language C is most suitable because it has a smaller memory requirement.

Because of the algorithm, verification of each calculation is feasible. Essentially the software traces the computation pulling out the parts used in the arithmetic. While Mathematica is usually used for more sophisticated computations than these type of arithmetical calculations its use is important in ensuring correctness (both due to its tested algorithms and numerical precision).

The importance of getting these computations right need not be understated but using Mathematica also opens up the possibility for further extensions (e.g. Graphs, feedback, more complicated drug or varied calculations)

To make the interface accessible from the Web, web Mathematica may be used while its formatting is controlled by CSS files which are automatically generated from within Mathematica. However the Java language could also be used with some benefits.

Extra columns can be seamlessly added and the fields easily customized to include other units.

It is within the scope of this invention to provide for machine reading of some of the inputs. This could include equiping a hand-held device according to this invention with the ability to read the barcode on the drug packaging and in particular import the drug's concentration values into its interface. This would enable pharmaceutical companies to avoid having to provide hospitals with all the variety of so-called “unit doses”, which are doses ready to be directly administered for all the different types of patients. With a bar-code reading facility the pharmaceutical companies would be able to continue with their current packaging as the automatic reading of the bar code would be converted by the device of this invention into a read out telling the nurse how much to measure out.

From the above it can be seen that the present invention provides a simple single interface that can deal with a wide range of computational situations. This invention differs from the prior art in that it offers a complete technological solution to the automation of drug calculations. This includes pedagogical design, transparency in the selected algorithm, inbuilt extensibility and back-end connections to an industrial strength computational engine and a comprehensive pharmacopoeia.

Those skilled in the art will realize that the embodiments illustrated are only some of many ways of presenting the input and output data and other formats may be used without departing from the essential teachings of this invention. That is, other embodiments and extensions can be built on but the inventions essential usability derives from the way in which it maximizes its Interface Efficiency or equivalently the way in which the invention minimizes the number of inputs relative to the range of possible dosage calculations an interface can offer.

1. A method of administering a drug to a patient which involves providing an interface for entry of data including one or more of drug identity, dosage rate, prescribed dosage form, concentration and form of drug, and patient body weight, processing the input data using an algorithm which converts the input data into a set of instructions for administering the drug including the amount and time for the first and subsequent administrations, administering the drug and recording the amount and times on the patients record.

2. A method as claimed in claim 1 in which the algorithm constructs a customized formula from the dose's description entered in the interface.

3. A method as claimed in claim 1 in which the interface is an input screen with input windows for dosage weights, dosage volumes and dosage time intervals and patient weight and buttons which allow the data entries to be utilized as a numerator or denominator or not be used in the calculation.

4. An interface for use in a method as defined in claim 1 in which the interface is an input screen with input windows for dosage weights, dosage volumes and dosage time intervals and patient weight and buttons which allow the data entries to be utilized as a numerator or denominator or not be used in the algorithm and the algorithm operated from the interface constructs a customized formula from the dose's description entered in the interface.

5. An interface screen as defined in claim 4 and illustrated in the drawings.
